(19) United States
(12) Patent Application Publication
(10) Pub. No.: US 2014/0151497 A1
(43) Pub. Date: Jun. 5, 2014

(54) ENGINE PYLON FOR AN AIRCRAFT

(71) Applicant: GE Aviation Systems LLC, (US)

(72) Inventors: Thomas Joseph Weir, Lutherville, MD (US); Allen Madsen Woolley, Rose Hill, KS (US); Carol Marie Janzon, Abingdon, MD (US)

(73) Assignee: GE AVIATION SYSTEMS LLC, Grand Rapids, MI (US)

(21) Appl. No.: 13/693,545

(22) Filed: Dec. 4, 2012

(51) Int. Cl. B64D 27/26

(52) U.S. Cl. CPC B64D 27/26
USPC 244/54

(57) ABSTRACT

An engine pylon for attaching an engine to an aircraft, where the engine pylon includes a monolithic support structure having a body that includes multiple spaced bulkheads, multiple longerons connecting the bulkheads to define multiple bays and skins provided on the frame to at least partially enclose at least one of the multiple bays.

### BACKGROUND OF THE INVENTION

Contemporary aircraft include pylon structures to support an engine on a wing of the aircraft. Contemporary engine pylons are built from many separate parts including frames, longerons, and skins, which may be assembled together using hundreds, if not more, high tolerance fasteners, which adds weight and cost. Holes to accommodate the fasteners for coupling the parts together may need to be drilled in the separate parts and makes the assembly process time consuming

### BRIEF DESCRIPTION OF THE INVENTION

In one embodiment, the invention relates to an engine pylon for an aircraft including a box-beam having multiple spaced bulkheads and multiple longerons connecting the bulkheads to define a frame with multiple bays, and skins provided on the frame to at least partially enclose at least one of the multiple bays, wherein at least a subset of the spaced bulkheads, multiple longerons, and skins are a monolithic structure.

In another embodiment, the invention relates to an engine pylon for attaching an engine to an aircraft, that includes a monolithic support structure having a body having an upper and a lower face spaced by a first sidewall and a second sidewall, multiple bays with each bay having an inlet adjacent at least one of the upper face, lower face, first sidewall, and second sidewall, skin on at least two of the upper face, lower face, first sidewall, and second sidewall.

### BRIEF DESCRIPTION OF THE DRAWINGS

In the drawings:

FIG. 1 is a schematic view of a portion of an aircraft including an engine and a pylon according to an embodiment of the invention.

FIG. 2 is a perspective view of an exemplary engine pylon according to an embodiment of the invention.

FIG. 3 is a perspective view of the engine pylon of FIG. 2 with opposing portions separated.

FIG. 4 is a partial cross-sectional view of the engine pylon of FIG. 2.

FIG. 5 is a perspective view of another exemplary engine pylon.

FIGS. 6A and 6B illustrate cut away views comparing a conventional pylon and a pylon according to an embodiment of the invention.

FIGS. 7A and 7B illustrate a second comparison of the number of fasteners used for a conventional pylon and a pylon according to an embodiment of the invention.

### DESCRIPTION OF EMBODIMENTS OF THE INVENTION

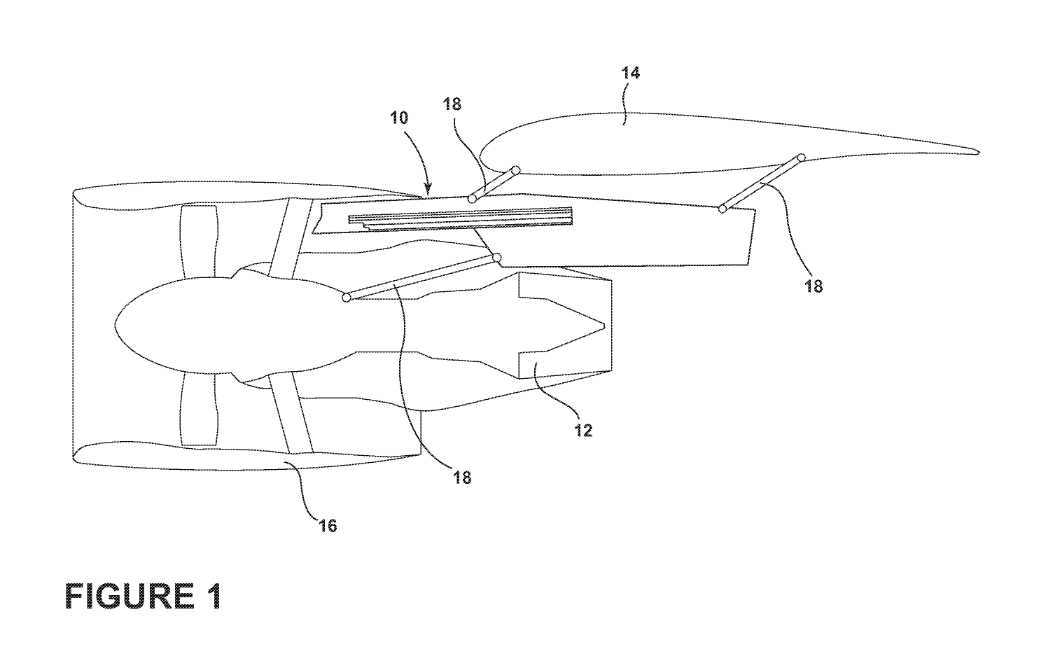

FIG. 1 illustrates an engine pylon 10 for securing an engine 12 to a wing 14 of an aircraft. A nacelle 16 has been shown partially cut away for clarity as the nacelle 16 surrounds the engine 12. A mounting system 18, which may include suspension structures, may be used to operably couple the engine pylon 10 between the engine 12 and the wing 14. While a commercial aircraft has been illustrated, it is contemplated that the embodiments of the invention may be used in any type of aircraft. Further, while the engine pylon 10 has been illustrated as coupling the upper portion of the engine 12 to the leading edge and under side of the wing 14 other mounting arrangements and mounting systems may be used.

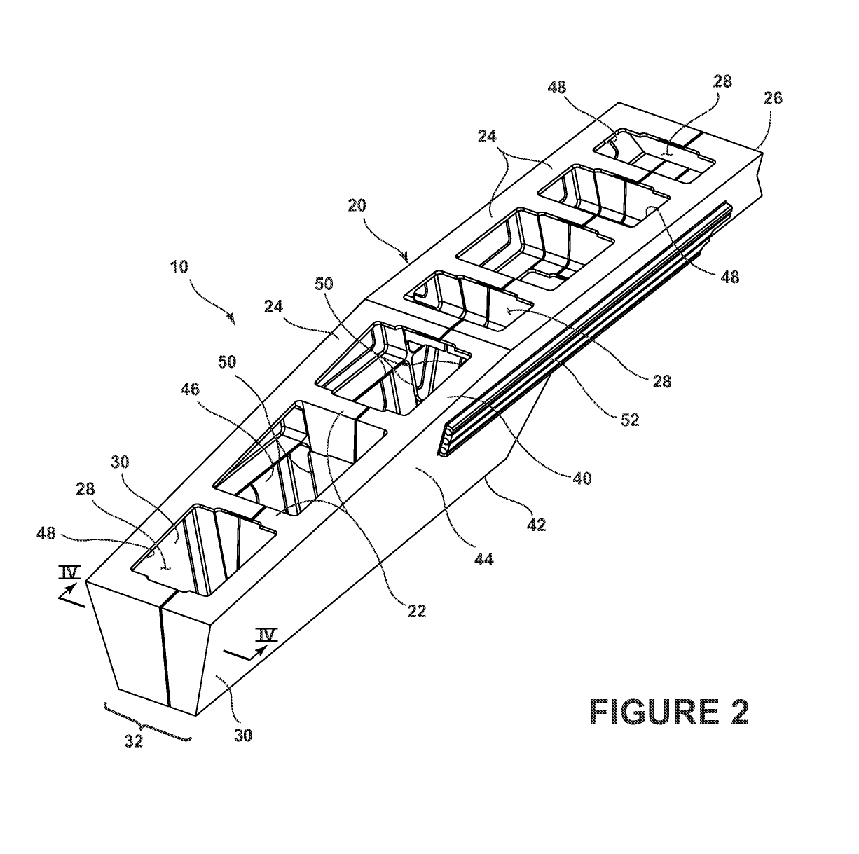

FIG. 2 more clearly illustrates that the engine pylon 10 includes a body or box-beam 20 having multiple spaced bulkheads 22. Multiple longerons 24 connect the spaced bulkheads 22 to define a frame 26 with multiple bays 28. Skin 30 may be provided on the frame 26 to at least partially enclose at least one of the multiple bays 28.

At least a subset of a portion of the spaced bulkheads 22, multiple longerons 24, and skins 30 form a monolithic support structure 32. In the illustrated example, the monolithic support structure 32 includes an upper face 40 and a lower face 42 spaced by a first sidewall 44 and a second sidewall 46. The multiple bays 28 each have an inlet 48 adjacent to the upper face 40. It will be understood that the inlet 48 may be adjacent to any of at least one of the upper face 40, lower face 42, first sidewall 44, and second sidewall 46. The box-beam 20 may be shaped in any suitable manner including that the body may taper from the upper face 40 to the lower face 42.

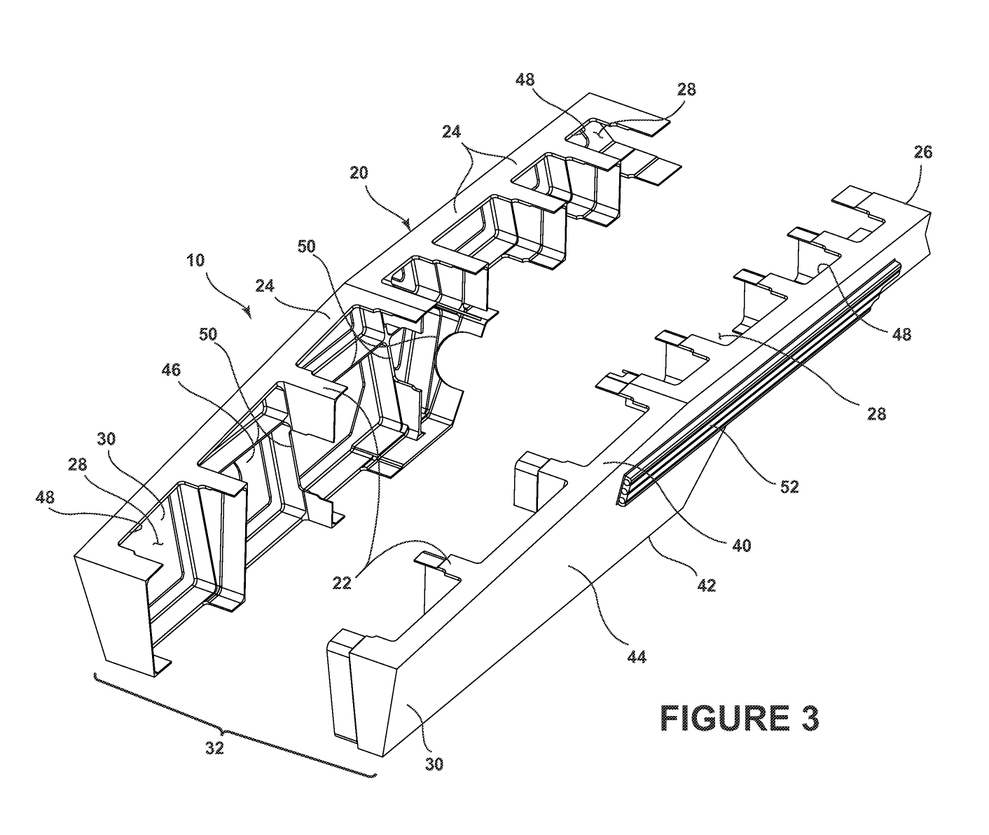

Skin 30 may be included on at least two of the upper face 40, lower face 42, first sidewall 44, and second sidewall 46. In FIG. 3, it may more easily be seen that skin 30 has been included on the first sidewall 44 and the second sidewall 46. It may also be more easily seen that the monolithic support structure 32 also includes integral internal support web members 50 for providing structural support to the engine pylon 10. The internal support web members 50 may be oriented in any direction including diagonally within the box-beam 20.

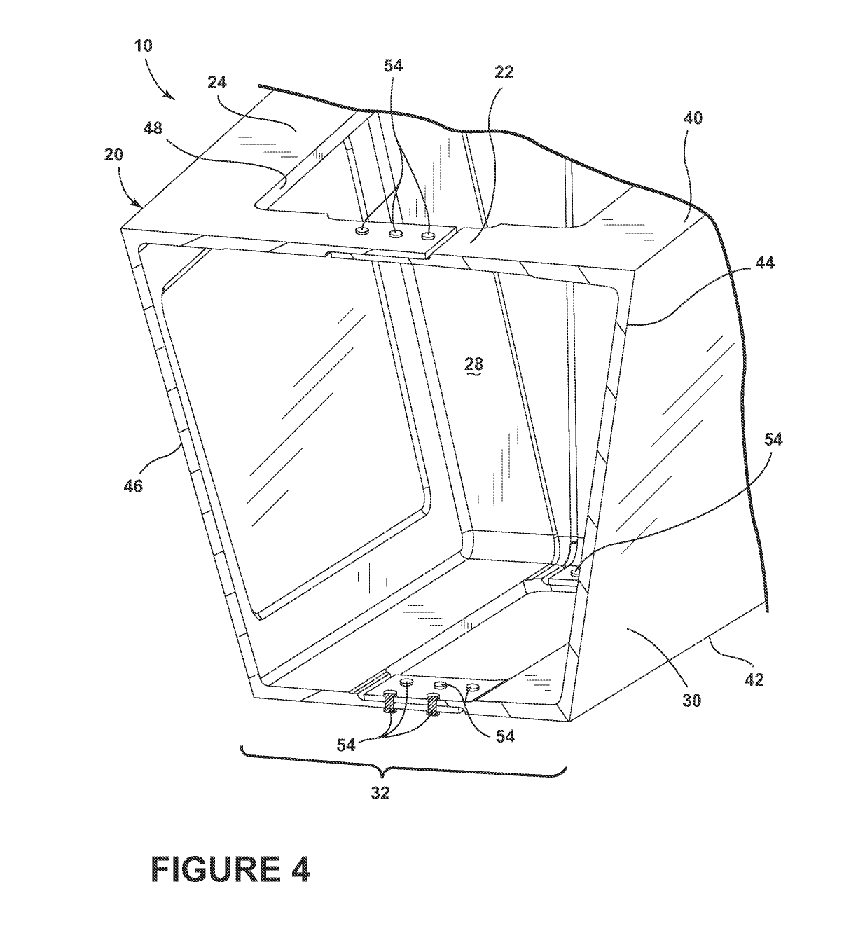

It is also contemplated that a thrust reverser with at least one movable element, which is movable to and from a reversing position, may be included on the engine to change the direction of airflow. There are several methods of obtaining reverse thrust on engine assemblies; however, these components these components are not germane to the present invention and will not be described further herein. As illustrated, an integrated thrust reverser track 52 may extend from a side of the box-beam 20. One or more of the components of the thrust reverser may utilize the thrust reverser track 52 for movement of the thrust reverser to and from the reversing position. In the illustrated example in FIG. 4, the two opposing pieces are joined by fasteners 54. The fasteners 54 have been schematically illustrated and any suitable fasteners 54 may be used. The two opposing monolithic structures may be joined together along any suitable joint including an overlapping joint. While a stepped lap joint has been illustrated it will be understood that any suitable joint including a double shear joint, butt joint, etc. may be used.

The box-beam 20 of the engine pylon 10 has been illustrated as including two opposing monolithic structures, left and right longitudinal halves, which may be joined together to form the monolithic support structure 32. It will be understood that the monolithic support structure 32 may be formed from any suitable material. Further, the monolithic structure may be formed using any suitable manufacturing process. By way of non-limiting example, the monolithic support structure 32 may be forged or machined from one or more pieces of aluminum and then joined together. Splitting the monolithic support structure 32 into two sections facilitates conventional machining operations. The two opposing monolithic structures may be joined in any suitable manner including through fastening, welding, friction-stir welding, etc. The monolithic support structure 32 is unique as compared to a contemporary pylon in that a subset of the spaced bulkheads 22, multiple longerons 24, and skin 30 are integrally formed to create the monolithic structure 32. For example, as indicated above, each of the opposing monolithic structures, including the spaced bulkheads 22, multiple longerons 24, and skin 30 may be machined from a single piece of material. It will be understood that while the spaced bulkheads 22, multiple longerons 24, and skin 30 have been called out within the monolithic structure 32 that each of these components is not typical of the bulkheads, longerons, and skin in a contemporary pylon because the spaced bulkheads 22, multiple longerons 24, and skin 30 as well as other features of the above embodiment are integrally formed together instead of being separate parts.

While the monolithic support structure 32 has been illustrated as being split into the two exemplary opposing pieces in FIGS. 2-4 it will be understood that other methods of splitting the monolithic support structure 32 may be more advantageous depending on the layout of the engine pylon 10 and the method of manufacture. Furthermore, wing connection fittings and engine mounts may also be incorporated during manufacture to take advantage of the split in the monolithic support structure 32 to sandwich fittings.

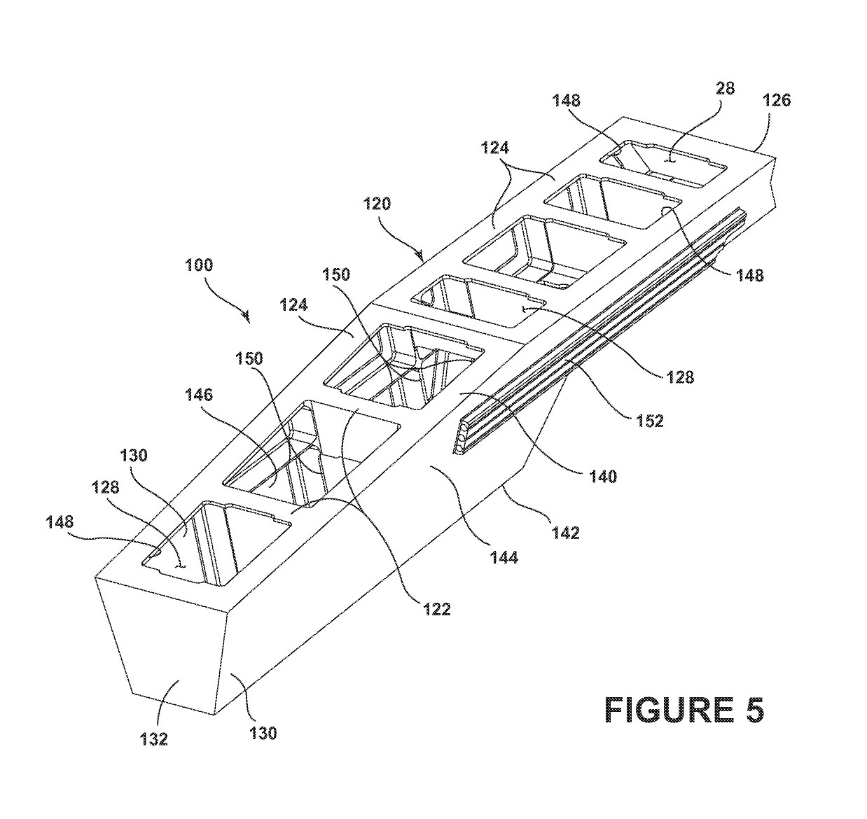

FIG. 5 is a perspective view of another exemplary engine pylon 100. The engine pylon 100 is similar to the engine pylon 10 previously described and therefore, like parts will be identified with like numerals increased by 100, with it being understood that the description of the like parts of the engine pylon 10 apply to the engine pylon 100, unless otherwise noted.

One difference is that the body or box-beam 120 includes a single-piece monolithic support structure 132 forming all of the spaced bulkheads 122, longerons 124, and skins 130. As with the previously described engine pylon 10 it will be understood that the monolithic support structure 132 may be formed from any suitable material using any suitable manufacturing process. For example, the monolithic support structure 132 may be formed from a single piece of machined aluminum. By way of non-limiting example, the inlets 148 or portions of the inlets 148 may initially be formed by an EDM wire and an initial portion of the aluminum may be removed. Following the removal of the initial portions the spaced bulkheads 122, multiple longerons 124, multiple bays 128, and any integral internal support web members 150 may be formed through additional machining. The separate steps in the thickness of the monolithic support structure 132 allow for the right amount of structure needed for the anticipated loads without having too much structure. This results in weight savings, which translates to fuel and cost savings.

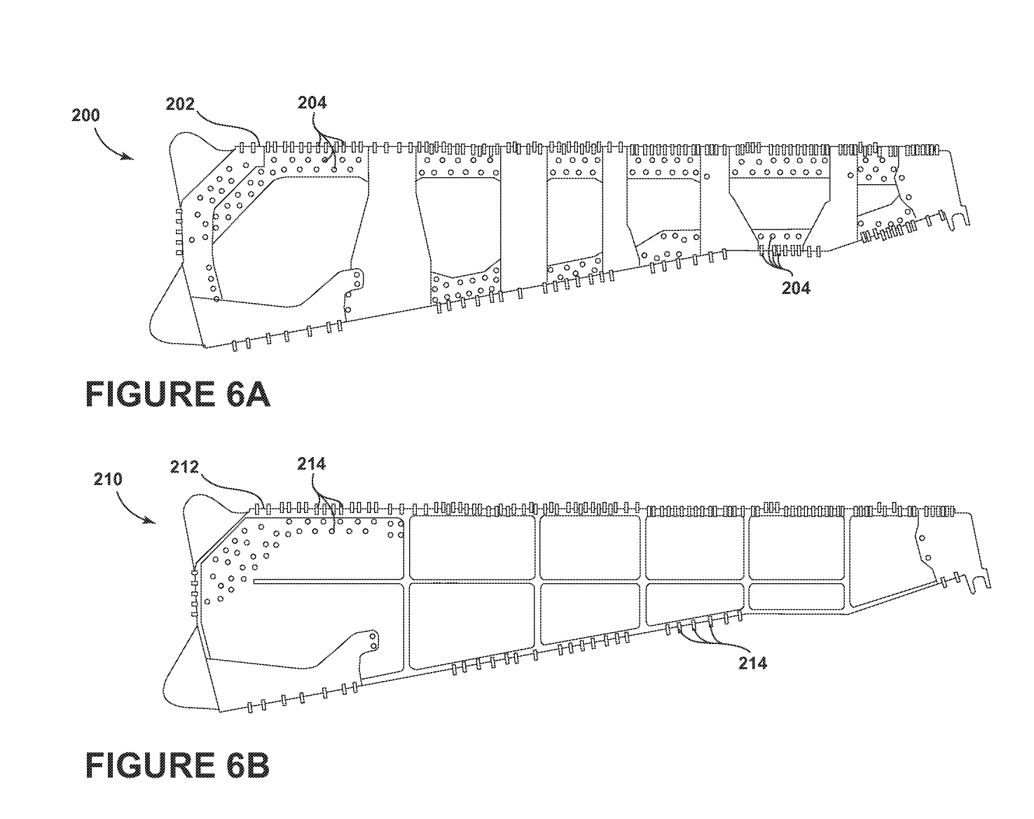

The embodiments described above both include a monolithic structure incorporating at least some of the skins, longerons, and bulkheads. This is in contrast to the historically-used, separate mechanically attached parts used for conventional pylon construction. FIGS. 6A and 6B illustrate cut away views comparing a more conventional pylon 200 and a pylon 210 according to an embodiment of the invention. More specifically, the pylon 200 illustrated in FIG. 6A includes a body 202 according to a more conventional pylon construction, which includes separate skins, longerons, and bulkheads and uses fasteners 204 to interconnect components. Conversely, the pylon 210 illustrated in FIG. 6B includes a monolithic structure 212 as described above. As may be easily seen, the number of fasteners 214 utilized with the pylon 210 is much less than those used for the more conventional pylon 200.

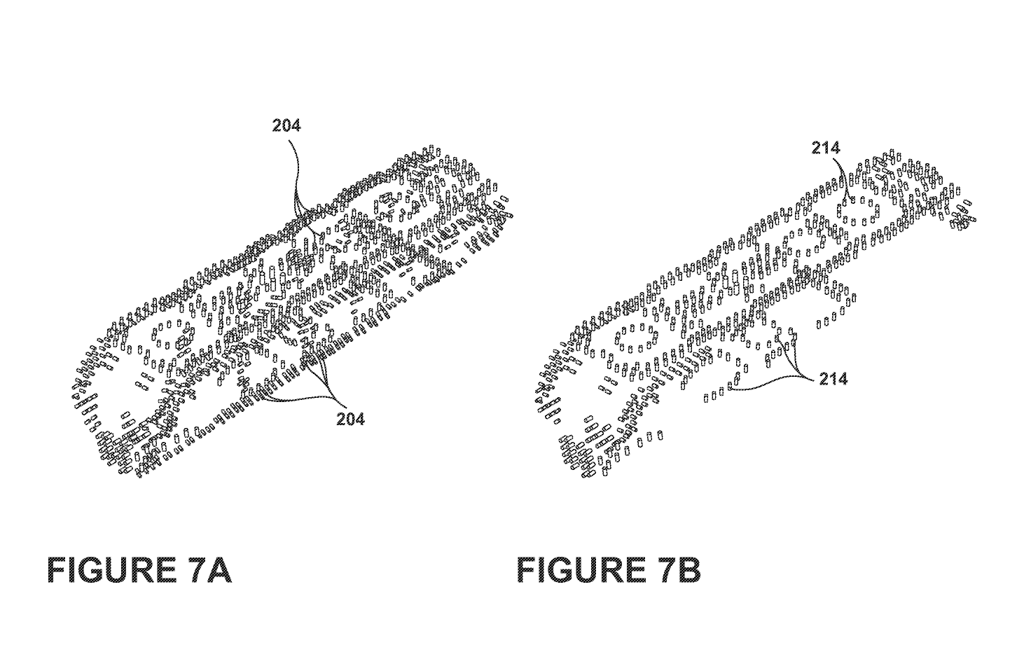

FIGS. 7A and 7B further illustrate the savings in fasteners. FIG. 7A illustrates a typical number of fasteners 204 used for a more conventional pylon and FIG. 7B illustrates a typical number of fasteners 214 used for a pylon according to an embodiment of the invention. As is easily seen, the number of fasteners 214 for a pylon according to an embodiment of the invention is much less than the number of fasteners used for a more conventional pylon. It is contemplated that the above described embodiments result in a reduced number of fasteners in the pylon by approximately sixty percent as compared to more conventional pylons. This results in an overall weight benefit of approximately twenty percent. Assuming the fasteners equal ten percent of the part cost this may result in a cost reduction of five percent.

In addition to the weight and cost savings, the embodiments described above provide for a variety of additional benefits including that numerous fastener holes likely to induce fatigue cracks are eliminated as the monolithic structure is not built from many separate parts like a contemporary pylon is. Further, fastened joints that result in heavier structure are reduced. Further still, shim gaps that increase assembly time, and weaken the fastened joint are eliminated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An engine pylon for an aircraft comprising:
a box-beam having multiple spaced bulkheads, multiple longerons connecting the bulkheads to define a frame with multiple bays, and skins provided on the frame to at least partially enclose at least one of the multiple bays, wherein at least a subset of the spaced bulkheads, multiple longerons, and skins are a monolithic structure.

2. The engine pylon of claim 1 wherein the frame further comprises integral internal support web members for providing structural support to the engine pylon.

3. The engine pylon of claim 1 wherein the box-beam comprises a single piece monolithic structure forming all of the bulkheads, longerons, and skins.

4. The engine pylon of claim 3 wherein the single piece comprises a single piece of machined aluminum.

5. The engine pylon of claim 1 wherein the box-beam comprises two opposing monolithic structures joined together.

6. The engine pylon of claim 5 wherein the two opposing monolithic structures are joined together along a stepped lap joint.

7. The engine pylon of claim 5 wherein the two opposing monolithic structures are joined by fasteners.

8. The engine pylon of claim 1 wherein the monolithic structure further comprises an integrated thrust reverser track extending from a side of the box-beam.

9. An engine pylon for attaching an engine to an aircraft, the engine pylon comprising:
a monolithic support structure having a body, comprising:
an upper face and a lower face spaced by a first sidewall and a second sidewall;
multiple bays with each bay having an inlet adjacent at least one of the upper face, lower face, first sidewall, and second sidewall; and
skin on at least two of the upper face, lower face, first sidewall, and second sidewall.

10. The engine pylon of claim 9 wherein the body tapers from the upper face to the lower face.

11. The engine pylon of claim 9 wherein the body further comprises a single piece.

12. The engine pylon of claim 11 wherein the single piece comprises a single piece of machined aluminum.

13. The engine pylon of claim 9 wherein the body further comprises two pieces joined together.

14. The engine pylon of claim 13 wherein the two pieces are joined together along a stepped lap joint.

15. The engine pylon of claim 13 wherein the two pieces are joined by fasteners.

16. The engine pylon of claim 9 wherein the body further comprises integral internal support web members for providing structural support to the body.
